(19) United States
(12) Patent Application Publication
(10) Pub. No.: US 2016/0039433 A1
(43) Pub. Date: Feb. 11, 2016

(54) PROPPANT STORAGE AND TRANSFER SYSTEM AND METHOD

(71) Applicant: Oren Technologies, LLC, Houston, TX (US)

(72) Inventors: John Oren, Houston, TX (US); Joshua Oren, Houston, TX (US)

(21) Appl. No.: 14/922,836

(22) Filed: Oct. 26, 2015

Related U.S. Application Data
(63) Continuation-in-part of application No. 14/738,485, filed on Jun. 12, 2015.
Application No. 14/738,485 is a continuation-in-part of application No. 13/768,962, filed on Feb. 15, 2013.
Application No. 13/768,962 is a continuation-in-part of application No. 13/628,702, filed on Sep. 27, 2012.
Application No. 13/628,702 is a continuation-in-part of application No. 13/555,635, filed on Jul. 23, 2012.
Application No. 13/555,635 is a continuation-in-part of application No. 29/537,567, filed on Aug. 27, 2015.
Application No. 29/537,567 is a reissue of application No. 29/455,204, filed on May 17, 2013, now Pat. No. D703582.
Application No. 29/455,204 is a continuation-in-part of application No. 14/310,648, filed on Jun. 20, 2014.
Application No. 14/310,648 is a continuation of application No. PCT/US13/32819, filed on Mar. 18, 2013.
Application No. PCT/US13/32819 is a continuation of application No. 13/427,140, filed on Mar. 22, 2012, now Pat. No. 8,622,251.
Application No. 13/427,140 is a continuation-in-part of application No. 13/332,937, filed on Dec. 21, 2011, now Pat. No. 8,827,118.
(60) Provisional application No. 62/139,323, filed on Mar. 27, 2015.
(60) Provisional application No. 62/012,153, filed on Jun. 13, 2014.
(60) Provisional application No. 62/012,165, filed on Jun. 13, 2014.
(60) Provisional application No. 62/139,323, filed on Mar. 27, 2015.

(51) Int. Cl. B61D 3/20; B65G 67/02; B65D 88/54

(52) U.S. Cl. CPC B61D 3/20; B65D 88/54; B65G 67/02

(57) ABSTRACT

Embodiments of the present disclosure include a rail car for supporting and transporting one or more containers storing proppant therein. A spine member extends from a first end to a second end of the rail car, and having a variable height that is greater at a midpoint than at the ends. A bolster is arranged on a top surface of the spine member, extends laterally in two directions, and has a greater width proximate the spine member than at a distal end. A mounting platform is positioned on the distal end of the bolster, has a container surface that receives the one or more containers, and extends vertically from the bolster to position the container above a top surface of the bolster. A locking assembly is positioned on the mounting platform and secures the one or more containers to the rail car when moved to a locked position.

### CROSS-REFERENCE TO RELATED APPLICATIONS

The present application claims priority to and the benefit of U.S. Provisional Application No. 62/139,323, filed on Mar. 27, 2015, and titled “Spine Car for Transporting Proppant Containers,” which is hereby incorporated by reference in its entirety. The present application further is a continuation-in-part of U.S. patent application Ser. No. 14/738,485, filed Jun. 12, 2015, and titled “Apparatus for the Transport and Storage of Proppant,” which is a continuation-in-part of U.S. application Ser. No. 13/768,962, filed on Feb. 15, 2013, and titled “Support Apparatus for Moving Proppant from a Container in a Proppant Discharge System,” which is a continuation-in-part of U.S. application Ser. No. 13/628,702, filed on Sep. 27, 2012, and titled “Proppant Discharge System and a Container for Use in Such a Proppant Discharge System,” which is a continuation-in-part of U.S. application Ser. No. 13/555,635, filed on Jul. 23, 2012, and titled “Proppant Discharge System Having a Container and the Process for Providing Proppant to a Well Site.” U.S. patent application Ser. No. 14/738,485 further claims priority to and the benefit of U.S. Provisional Application 62/012,153, filed on Jun. 13, 2014, and titled “Process and System for Supplying Proppant from a Mine to a Transport Vehicle,” U.S. Provisional Application 62/012,165, filed on Jun. 13, 2014, and titled “Apparatus for the Transport and Storage of Proppant,” and U.S. Provisional Application 62/139,323, filed on Mar. 27, 2015, and titled “Spine Car for Transporting Proppant Containers,” each of which is hereby incorporated by reference in its entirety. The present application still further is a continuation-in-part of U.S. Patent Application No. 29/537,567, filed on Aug. 27, 2015, and titled “Train Car for Proppant Containers,” which is a reissue of U.S. Pat. No. D703,582, filed on May 17, 2013, and titled “Train Car for Proppant Containers,” each of which is hereby incorporated by reference in its entirety. The present application yet still further is a continuation-in-part of U.S. patent application Ser. No. 14/310,648, filed on Jun. 20, 2014, titled “Method of Delivering, Transporting, and Storing Proppant for Delivery and Use at a Well Site,” which is continuation of PCT Application No. PCT/US13/32819, filed on Mar. 18, 2013, titled “System of Delivering and Storing Proppant for Use at a Well Site and Container for Such Proppant,” which claims the benefit of U.S. patent application Ser. No. 13/427,140, filed on Mar. 22, 2012, titled “System of Delivering and Storing Proppant for Use at a Well Site and Container for Such Proppant,” now U.S. Pat. No. 8,622,251, issued on Jan. 7, 2014, which is a continuation-in-part of U.S. patent application Ser. No. 13/332,937 filed on Dec. 21, 2011, titled “Proppant Storage Vessel and Assembly Thereof,” now U.S. Pat. No. 8,827,118, issued on Sep. 9, 2014, all of which are incorporated herein by reference in their entireties.

### BACKGROUND OF THE INVENTION

1. Field of the Invention

The present invention relates to the oil and gas industry and, more particularly, to the transport and storage of proppant.

2. Description of Related Art

Hydraulic fracturing is the propagation of fractions in a rock layer caused by the presence of pressurized fluid. Hydraulic fractures may form naturally, in the case of veins or dikes, or may be man-made in order to release petroleum, natural gas, coal seam gas, or other substances for extraction. Fracturing is done from a wellbore drilled into reservoir rock formations. The energy from the injection of a highly-pressurized fracking fluid creates new channels in the rock which can increase the extraction rates and ultimate recovery of fossil fuels. The fracture width is typically maintained after the injection by introducing a proppant into the injected fluid. Proppant is a material, such as grains of sand, ceramic, or other particulates, that prevents the fractures from closing when the injection is stopped.

A dominant proppant is silica sand, made up of ancient weathered quartz, the most common mineral in the Earth's continental crust. Unlike common sand, which often feels gritty when rubbed between the fingers, sand used as a proppant tends to roll to the touch as a result of its round, spherical shape and tightly-graded particle distribution. Sand quality is a function of both deposit and processing. Grain size can be a key factor, as any given proppant must reliably fall within certain mesh ranges, subject to downhole conditions and completion design. Generally, coarser proppant allows for higher flow capacity due to the larger pore spaces between grains. It may break down, however, or crush more readily under stress due to the relatively fewer grain-to-grain contact points to bear the stress often incurred in deep oil- and gas-bearing formations.

Commonly, the proppant (e.g., the silica sand) is mined at a quarry and loaded into containers (e.g., sand hoppers) for storage and subsequent transportation to staging areas, well sites, or the like. For example, the proppant may be loaded into a sand hopper connected to a locomotive to transport the sand hopper to a different location for subsequent preparation and loading of the proppant. The sand hopper may be unloaded at a staging area and then loaded onto pneumatic trucks for delivery to well sites. This process involves several loading and unloading steps for the proppant, thereby increasing cost, shrinkage, and potentially hazardous working environments. Accordingly, it is now recognized that improved logistics for the storage and delivery of proppant is desirable.

### BRIEF SUMMARY OF THE INVENTION

In an embodiment, a rail car for supporting and transporting one or more containers storing proppant therein includes a spine member extending from a first end to a second end of the rail car, the spine member having a variable height that is greater at a midpoint of the spine member than at the first end and at the second end. The rail car also includes a bolster arranged on a top surface of the spine member and extending laterally off of the spine member in two directions, the bolster having a greater width proximate the spine member than at a distal end of the bolster. Furthermore, the rail car includes a mounting platform positioned on the distal end of the bolster and having a container surface that receives the one or more containers when arranged thereon, the mounting platform extending vertically from the bolster to position the one or more containers above a top surface of the bolster when positioned thereon. Moreover, the rail car includes a locking assembly positioned on the mounting platform to engage the one or more containers when positioned thereon, the locking assembly securing the one or more containers to the rail car when moved from an unlocked position to a locked position.

In a further embodiment a proppant storage and transportation system includes a plurality of containers arranged in a side-by-side configuration. Each container of the plurality of containers includes a pair of side walls, a pair of end walls, a top, a bottom, and inclined surfaces extending in a downward direction from the side walls and the end walls toward a discharge opening in the bottom to direct proppant stored therein out of the container via the discharge opening. The system also includes a rail car. The rail car includes a spine member extending from a first end to a second end, the spine member having a variable height that is greater at a midpoint than at the first and second ends. The rail car also includes a plurality of bolsters arranged along a length of the spine member, the plurality of bolsters extending laterally outward from the spine member. Also, each bolster of the plurality of bolsters has a distal end that is narrower than a proximal end. Furthermore, each bolster is arranged such that at least one container of the plurality of containers is in contact with at least one bolster of the plurality of bolsters when the at least one container is positioned on the rail car. The rail car also includes one or more mounting platforms arranged on the distal end of each bolster of the plurality of bolsters, the one or more mounting platforms extending vertically above a top surface of each bolster of the plurality of bolsters such that the at least one container arranged thereon is not in contact with the top surface of each bolster of the plurality of bolsters.

In an embodiment a method for filling and transporting proppant containers includes filling the proppant container through an opening in a top wall, the proppant container having inclined surfaces that direct the proppant therein toward a discharge opening. The method also includes positioning the proppant container onto a rail car, the rail car having one or more bolsters arranged transverse to a spine member. The one or more bolsters include mounting platforms to receive the container and to elevate the container above a top surface of the one or more bolsters. The method further includes transporting the proppant container, via the rail car, to a staging area. The method includes unloading the proppant container from the rail car and arranging the proppant container in a stacked configuration with one or more other proppant containers.

### BRIEF DESCRIPTION OF THE FIGURES

FIG. 1 is a perspective view of an embodiment of a container for the transport and storage of proppant, according to aspects of the present disclosure;

FIG. 2 is a cross-sectional elevation view of the container of FIG. 1, according to aspects of the present disclosure;

FIG. 3 is a side elevation view of the container of FIG. 1, according to aspects of the present disclosure;

FIG. 4 is an end elevation view of the container of FIG. 1, according to aspects of the present disclosure;

FIG. 5 is a bottom view of the container of FIG. 1, according to aspects of the present disclosure;

FIG. 6 is a perspective view of an embodiment of a rail car for receiving and supporting the container of FIG. 1, according to aspects of the present disclosure;

FIG. 7 is a side elevation view of the rail car of FIG. 6 having four containers positioned thereon, according to aspects of the present disclosure;

FIG. 8 is a top plan view of the rail car of FIG. 6, according to aspects of the present disclosure;

FIG. 9 is a further top plan view of the rail car of FIG. 6, according to aspects of the present disclosure;

FIG. 10 is a cross-sectional view taken along line 10-10 of FIG. 8, according to aspects of the present disclosure;

FIG. 11 is a perspective view of an embodiment of the container of FIG. 1 positioned relative to a locking mechanism of the rail car, according to aspects of the present disclosure;

FIG. 12 is a schematic view of the rail car of FIG. 6 coupled to an engine and positioned on a rail section, according to aspects of the present disclosure;

FIG. 13 is a perspective view of an embodiment of a system for the delivery of proppant, according to aspects of the present disclosure; and

FIG. 14 is a flow chart of an embodiment of a method for loading and transporting proppant in a container.

### DETAILED DESCRIPTION OF THE INVENTION

The foregoing aspects, features, and advantages of the present invention will be further appreciated when considered with reference to the following description of embodiments and accompanying drawings. In describing the embodiments of the invention illustrated in the appended drawings, specific terminology will be used for the sake of clarity. However, the invention is not intended to be limited to the specific terms used, and it is to be understood that each specific term includes equivalents that operate in a similar manner to accomplish a similar purpose.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments,” or “other embodiments” of the present invention are not intended to be interpreted as excluding the existence of additional embodiments that also incorporate the recited features. Furthermore, reference to terms such as “above,” “below,” “upper”, “lower”, “side”, “front,” “back,” or other terms regarding orientation are made with reference to the illustrated embodiments and are not intended to be limiting or exclude other orientations.

In hydraulic fracturing operations, a large amount of proppant is utilized, and it can be difficult to effectively store the proppant at the fracturing sites. Additionally, various difficulties may arise while transporting the proppant to a desired location. Proppant may be hauled to the desired locations on the back of trucks and clumped onsite. Under such circumstances, the proppant is exposed to adverse weather conditions. This may degrade the quality of the proppant during its storage. Additionally, the maintenance of proppant in containers at the hydraulic fracturing site requires a large capital investment in storage facilities. Typically, the unloading of such storage facilities is carried out on a facility-by-facility basis. As such, there is a need to be able to effectively transport the proppant to and store the proppant in a desired location adjacent to the hydraulic fracturing location.

With the development and acceptance of the well stimulation methodology known as “hydraulic fracturing,” a unique logistics challenge has been created in delivering the massive quantities of proppant from domestic sand mines to the wellhead. This logistics challenge affects every stakeholder up-and-down the logistics chain. In particular, this includes sand mine owners, railroads, trans-loading facilities, oil-field service companies, trucking companies and exploration and production companies. As such, a need for facilitating the ability to quickly and inexpensively off-load proppant from rail cars so as to enable railroads to improve the velocity, turn-around, and revenue-generating capacity of the rail-car fleet is present in the industry.

Furthermore, limited storage at trans-loading facilities has severely limited many of the current facilities' ability to operate efficiently. Most trans-load facilities are forced to off-load rail hopper cars by bringing in trucks (i.e. pneumatics) along the rail siding, and conveying sand directly from rail to truck. This requires an intense coordination effort on the part of the trans-loader as well as the trucking community. Long truck lines are commonplace, and demurrage fees (i.e. waiting time charged by trucking companies) amount to hundreds of millions of dollars nationwide. As such, throughput of these trans-loading terminals is reduced greatly, which costs the terminal meaningful revenue.

Additionally, trans-load terminal locations are not able to move from one area of the shale pay to another, and a potential loss of the investment in such immobile silos can often scare investment capital away from these types of future projects so as to further exacerbate the logistics chain problem. As such, a need has developed for a portable, inexpensive storage and delivery solution for proppant.

Furthermore, service companies (such as fracturing companies) are held captive by the current proppant delivery process. This is the result, in part, of inefficient trans-load facilities and pneumatic (bulk) truck deliveries. A service company cannot frac a well if it does not have a supply of proppant. Thus, pressure pumps, coiled tubing, and other well stimulation equipment sits idle due to the lack of required proppant at the well-site. “Screening-Out” or running out of proppant may occur at well locations due to the lack of control over what is happening up-stream in the proppant logistics chain.

Additionally, as will be described below, modular storage containers may be utilized to store and transport proppant from a sand quarry, a loading terminal, or the like. These modular containers may include ramped sections to facilitate the unloading of proppant from a controllable opening (e.g., a discharge opening) at a bottom of the container. However, an improper arrangement of plates (e.g., the ramped sections, funnel section) extending to the discharge opening of a container creates conflicting problems in the delivery of proppant. For example, if the funnel is at an angle that is too great, then it will occupy too much space within the interior of the container. As such, the desired ability to transport between 45,000 pounds and 48,000 pounds of proppant is compromised. Although the steep inclination of the funnel allows for the proper discharge of all of the proppant from the interior of the container, the containers are found to be unable to contain the desired amount of proppant. On the other hand, if the angle of the funnel is too shallow, then the proppant cannot be discharged properly from the bottom discharge opening. It is found that a certain amount of proppant will be retained within the interior volume of the container after discharge. As such, the full amount of the proppant cannot be delivered, by a conveyor, to the wellsite. Additionally, if the angle of the funnel is too shallow, certain bridging effects will occur with the proppant within the container. As such, this could block the flow of proppant properly moving outwardly of the discharge opening. Although a shallow angled funnel allows the container to receive the desired amount of proppant, the shallowness of the angle of the funnel works against the ability of the container to properly discharge the desired amount of proppant. As such, a properly configured funnel so as to maximize the amount of proppant contained within the container while, at the same time, assuring that all of the proppant within the container will be properly discharged by gravity discharge onto a conveyor is desirable to facilitate a modular proppant storage and transportation system.

Embodiments of the present disclosure include a rail car for receiving, supporting, and transporting one or more containers having proppant stored therein. The rail car includes a spine member extending from a first end to a second end and having a variable height. The variable height of the spine member is greater toward the center of the rail car, thereby providing additional strength and stability to the rail car when supporting a load (e.g., the containers). Moreover, the rail car includes one or more bolsters positioned along the length of the rail car. The bolsters extend from the spine member radially outward toward support rails perpendicularly positioned about the rail car. The bolsters include one or more mounting platforms at an end distal from the spine member to receive and support the containers. In certain embodiments, the mounting platforms include a container surface to receive a bottom of the container and to elevate the container above a top surface of the bolster. Further, the one or more mounting platforms each include a locking assembly to secure the containers to the bolsters. For example, the locking mechanisms may align with an opening or recess in the container when the container is positioned thereon. As a result, the one or more containers may be secured to the rail car for subsequent transportation.

Moreover, embodiments of the present disclosure are directed toward a method for loading and transporting proppant into containers. For example, the method includes loading the proppant into the containers at the mine and then positioning the containers onto a rail car configured to support one or more containers. As will be described in detail below, the rail cars may be specially configured to support approximately 260,000 pounds while still maintaining the structural integrity and mobility necessary to travel along traditional railways, rail yards, and bridges. The container may be transported to a staging area and then positioned onto a truck for transportation to the well site. At the well site, the container may be removed from the truck, stacked, and then emptied for utilization in a wellbore. Accordingly, the method disclosed herein may be utilized to reduce the number of handling steps proppant undertakes while being transported from a mine to a well site.

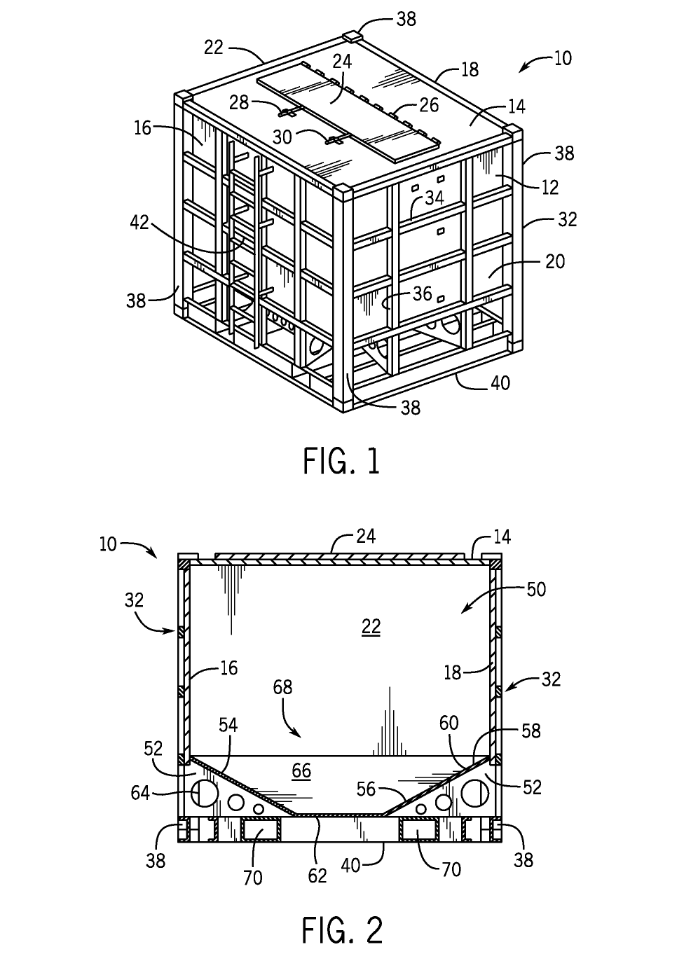

Turning to FIG. 1, a perspective view of a proppant container 10 is shown. The container 10 includes a storage body 12 formed at least partially by a top wall 14, a pair of side walls 16, 18, and a pair of end walls 20, 22. Moreover, the container 10 includes a bottom discharge opening (not shown) located below the pair of side walls 16, 18 and the pair of end walls 20, 22. In the illustrated embodiment, a hatch 24 is hingedly mounted to the top wall 14 so as to cover one or more openings in the top wall 14. As will be described below, the hatch 24 moves between an open position and a closed position to enable access to an interior volume of the storage body 12. For example, the hatch 24 may be moved to the open position while the container 10 is loaded with proppant and moved to the closed position during transportation and discharge.

In the illustrated embodiment, the top wall 14 is a generally planar surface. In other embodiments, however, the top wall 14 may include one or more surfaces positioned as various angles. For example, the top wall 14 may include a generally planar surface connected to surfaces having a generally downward slope on each side. As shown, the hatch 24 is connected by one or more hinges 26 to the top wall 14. The hinges 26 facilitate the transition of the hatch 24 from the open position to the closed position. Latches 28, 30 are utilized to secure the hatch 24 to the top wall 14 while the hatch 24 is in the closed position. That is, the latches 28, 30 are utilized to secure the hatch 24 over the one or more openings. In certain embodiments, the hatch 24 includes a liner or gasket to form a liquid-tight seal over the one or more openings formed in the top wall 14. The liner or gasket may interface with a lip (not pictured) positioned proximate the top wall 14. Accordingly, the container 10 may substantially isolate the proppant within the interior volume from the outside environment, thereby maintaining the integrity of the proppant by blocking and/or preventing moisture, dust, and other contaminants from entering the container 10. Moreover, the liquid-tight seal blocks silica dust from exiting the container 10 when the hatch 24 is in the closed position.

In the illustrated embodiment, the side walls 16, 18 and the end walls 20, 22 form a substantially rectangular configuration at least partially finding the interior volume of the storage body 12. As shown, a frame 32 is positioned about exterior surfaces of the side walls 16, 18 and the end walls 20, 22. While the illustrated embodiment is a perspective view and illustrates the frame 32 on the side wall 16 and the end wall 20, it is appreciated that the frame 32 extends about each side of the container 10 in a substantially similar configuration. The frame 32 includes horizontal members 34 and vertical members 36 arranged in a substantially cage-like, cross-hatched, checkered pattern. As a result, in the illustrated embodiment, horizontal members 34 and the vertical members 36 form substantially rectangular sections on the exterior surfaces of the walls 16, 18, 20, 22. It should be appreciated, however, that in certain embodiments the frame 32 may include only horizontal members 34, only vertical members 36, or different arrangements of horizontal members 34 and vertical members 36 on the walls 16, 18, 20, 22. In certain embodiments, the horizontal members 34 and the vertical members 36 are formed from square tubing bears against the outer surfaces of the respective walls 16, 18, 20, 22. As such, the frame 32 contributes to the structural integrity of the container 10. As that, the frame 32 prevents the proppant stored within the container 10 from driving the walls 16, 18, 20, 22 outward, thereby causing bulging of the walls 16, 18, 20, 22. In this manner, large loads of proppant (e.g., between 40,000 and 48,000 pounds) may be placed within the interior volume of the container 10 while maintaining the structural integrity of the container 10. Moreover, it is appreciated that in other embodiments larger loads of proppant may be placed into the interior volume of the container 10.

In the illustrated embodiment, the frame 32 includes corner posts 38 to further enhance the structural integrity of the container 10. As shown, the horizontal members 34 abut the corner posts 38. The corner posts 38 are positioned at the intersection between the sidewalls 16, 18 and the end walls 20, 22 to provide structural integrity to the substantially 90 degree intersection between the sidewalls 16, 18 and the end walls 20, 22. The corner posts 38 extend to a bottom 40. As will be described below, the discharge opening is positioned in the bottom 40.

The illustrated container 10 further includes a ladder 42 coupled to the sidewall 16. The ladder 42 extends vertically upwards from the bottom 40 to the top wall 14, thereby facilitating access to the top wall 14. For example, an operator may climb up the ladder onto the top wall 14 to move the hatch 24 from the closed position to the open position.

FIG. 2 is a cross-sectional elevation view of the container 10. In the illustrated embodiments, frame 32 is positioned on the exterior surface of the side walls 16, 18 and the corner posts 38 extend toward the bottom 40. As shown, the hatch 24 is in the closed position on the top wall 14 and an interior volume 50 of the storage body 12 is at least partially defined by the side walls 16, 18 and the end wall 22.

The container 10 includes gussets 52 coupled to and supporting respective inclined surfaces 54, 56 (e.g., ramps). The gussets 52 have a top surface 58 coupled to a bottom surface 60 of the respective inclined surfaces 54, 56 such that the downward incline of the gussets 52 is substantially equal to the downward incline of the inclined surfaces 54, 56. As shown, the gussets 52 extend laterally inward from the frame 32 toward a discharge opening 62. In the illustrated embodiments, the gussets 52 include holes 64 particularly selected to reduce the weight of the gussets 52 (and thereby reduce the weight of the container 10) while providing sufficient structural strength to support the inclined surfaces 54, 56. As will be appreciated, multiple gussets 52 may be utilized to support the inclined surfaces 54, 56. For example, a gusset (not shown) may support an inclined surface 66 extending from the end wall 22.

The inclined surfaces 54, 56, 66 (e.g., side plates, end plates) form a discharge area 68 having a funnel shape to direct proppant from the interior volume 50 toward the discharge opening 62. The angle of the side plates and end plates helps to facilitate substantially complete discharge of the material (e.g., proppant) within the container through the discharge opening 62. Yet, the angle of the inclined surfaces is particularly selected such that a maximum amount of proppant can be contained within the interior volume of the container 10. In certain embodiments, this volume will be between 45,000 pounds and 48,000 pounds of proppant. In particular, the angle defined by the inclined surfaces 55, 56 and the gussets 52, can be at an angle of greater than 250 with respect to the horizontal. In particular, the pair of end plates can extend in an angle of less than 37° with respect to the horizontal. In an embodiment of the present invention, the end plates extend at an angle of approximately 310 with respect to horizontal. Similarly, the inclined surface 66 also can extend at an angle of greater than 25° with respect to horizontal. The pair of side plates can extend at an angle of greater than 30° with respect to horizontal. In an embodiment the present invention, each of the pair of side plates extends at an angle of 380 with respect to the horizontal. It is appreciated that the inclined surfaces may be arranged at an angle particularly selected to facilitate drainage while maximizing the interior volume 50. For example, in embodiments, the angle may be between 20 and 50 degrees, 30 and 60 degrees, or the like.

As shown in FIG. 2, sleeves 70 are arranged at the bottom 16. The sleeve 70 may be sized to receive the forks of a forklift truck, for example. As will be described in detail below, the forklift truck may be utilized to lift and move the container 10 along the supply change as proppant to stored and transported from a mine to a well site.

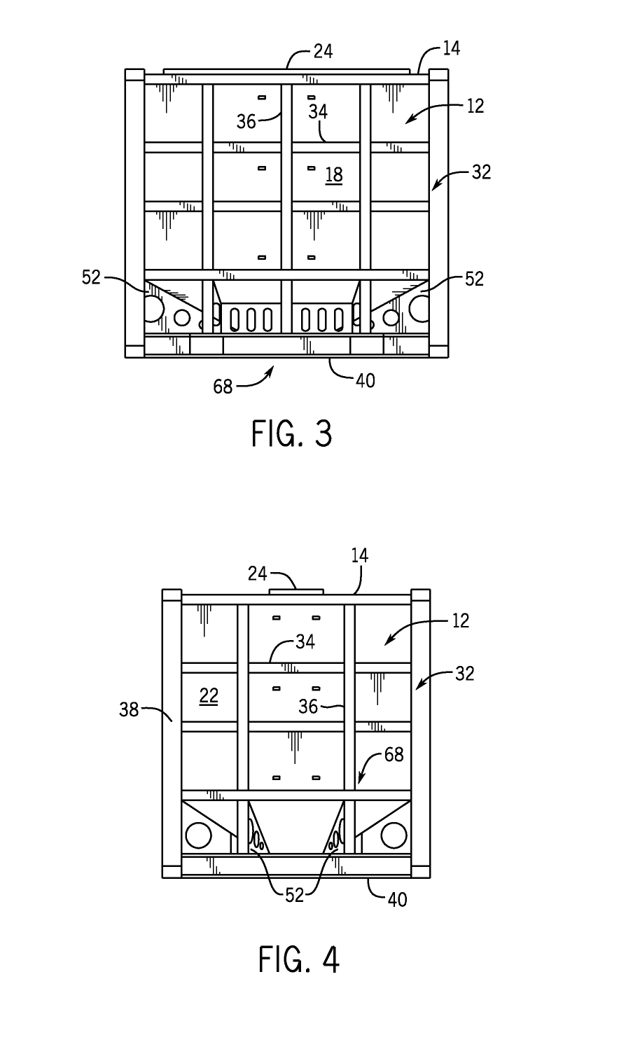

FIG. 3 is a side elevation view of the container 10 illustrating an embodiment of the sidewall 18. As described above, the frame 32 includes the horizontal members 34 and the vertical members 36 extending in a cross-hatch manner to provide structural support to the storage body 12. Moreover, the discharge area 68 is positioned proximate the gussets 52 to facilitate drainage of the proppant from the interior volume 50.

FIG. 4 is a side elevation view of the container 10 illustrating an embodiment of the end wall 22. In the illustrated embodiment, the frame 32 forms the cross-hatch pattern to provide structural support to the storage body 12. However, as described above, in other embodiments the frame 32 may include other configurations such as only having the horizontal members 34 or only having the vertical members 36. Moreover, as shown, the gussets 52 extend inwardly from the exterior of the container 10 toward the discharge opening 62 such that the gussets 52 support the inclined surfaces of the discharge area 68. Accordingly, the container 10 is configured to support, transport, and discharge proppant.

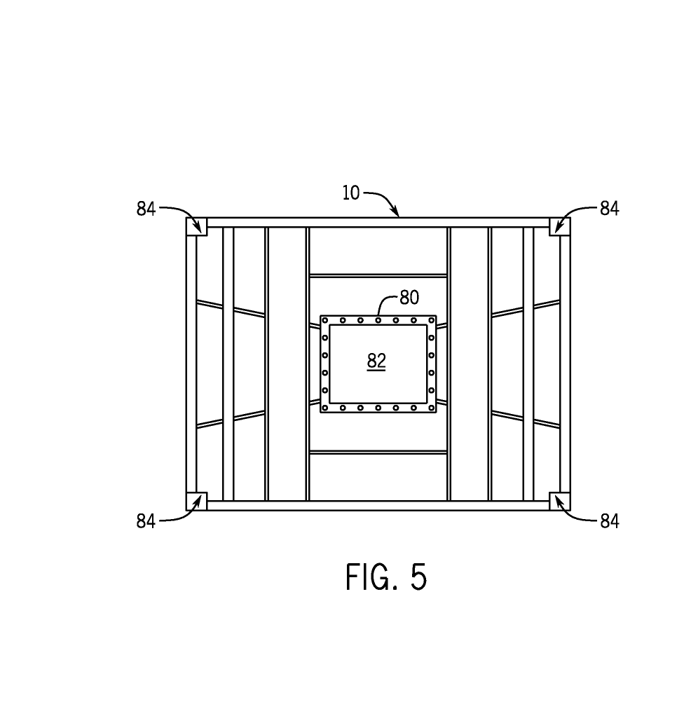

FIG. 5 is a bottom view of an embodiment of the container 10. In the illustrated embodiment, a reinforcing plate 80 surrounds a perimeter of the discharge opening 62. As will be appreciated, while the discharge opening 62 is substantially rectangular in the illustrated embodiment, the other embodiments the discharge opening 62 may be circular or any polygonal shape to facilitate draining the proppant from the interior volume of the container 10. The reinforcing plate 80 enhances the structural integrity of the discharge opening 62 by coupling the inclined surfaces (e.g., inclined surface 54, 56, 66) together. Moreover, the discharge opening 62 includes a gate 82. The gate 82 may be selectively opened and closed to enable the discharge of proppant from the container 10. For example, the gate 82 may be hydraulically actuated, mechanically actuated, electronically actuated, or the like.

Moreover, the frame 32 is shown substantially surrounding the perimeter of the storage body 12. In the illustrated embodiment, the corner posts 38 include openings 84 configured to receive one or more fasteners to mechanically secure the container to a stand, structure, cradle, truck, or railroad car. The illustrated openings 84 are substantially rectangular and include one or more receptacles to couple the container 10 to the stand, structure, cradle, truck, railroad car, or the like.

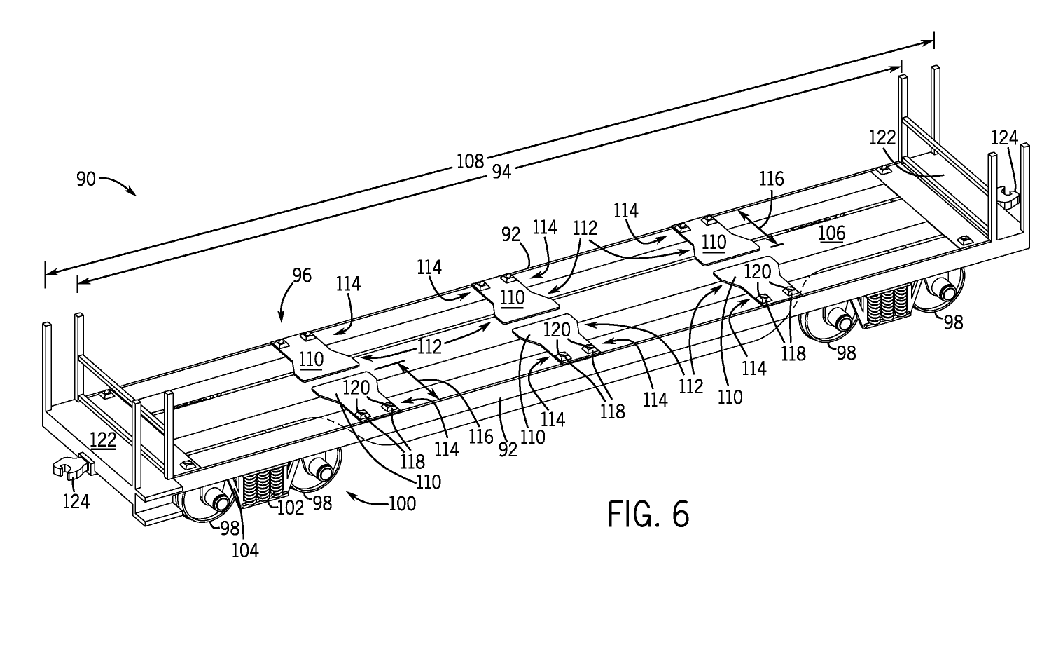

FIG. 6 is a perspective view of an embodiment of a rail car 90 configured to support and/or transport at least one container 10. As shown, the rail car 90 includes support rails 92 extending about a periphery of the rail car 90. The support rails 92 are positioned to add structural integrity to the rail car 90 to facilitate handling of the one or more containers 10. As will be described below, in certain embodiments, the rail car 90 has four containers 10 positioned in a side-by-side configuration along a length 94 of a load section 96 of the rail car 90. In certain embodiments, the containers 10 can hold approximately 48,000 pounds of proppant, thereby having a weight of approximately 54,000 to 58,000 pounds. Accordingly, the rail car 90 is designed to support the weight of up to four containers 10, or approximately 216,000 pounds to 232,000 pounds by disturbing the weight substantially equally across the trucks 98.

The rail car 90 includes the trucks 98 which interact with rails (not pictured) to facilitate movement of the rail car 90. The trucks 98 engage a weight management system 100 which includes one or more springs 102 to extend and/or compress to accommodate loads placed on the rail car 90. For example, the springs 102 are positioned proximate to strut members 104 coupled to the trucks 98. As a load is placed on the rail car 90, the springs 102 compress, thereby absorbing at least a portion of the load placed on the rail car 90. As a result, a greater quantity of weight may be placed on the rail car 90.

The illustrated rail car 90 is a “spine car” having an elongated spine member 106 oriented along a rail car length 108. As will be described in detail below, the spine member 106 has a variable height (e.g. elevation relative to the ground) at a center portion of the spine member 106. In other words, the height of the spine member 106 may be substantially uniform and then change near the mid portion of the spine member 106 and then return to being substantially uniform. The spine member 106 includes reinforcement at the sections having a changing height, thereby further increasing the structural integrity and support capabilities of the rail car 90.

As shown, the rail car 90 includes bolsters 110 transversely mounted to the spine member 106 and radially outward from the spine member 106 toward the support rails 92. In the illustrated embodiments, the bolsters 110 are coupled to the spine member 106 at a proximal end 112 and to the support members 104 at a distal end 114. Moreover, as will be described below, the bolsters 110 have a variable width along a length 116 of the bolsters 110. In other words, the width of the bolsters 110 is narrower at the distal end 114 than at the proximal end 112. Varying the width of the bolsters 110 improves the structural support and integrity of the bolsters 110, and thereby the rail car 90. For example, increasing the width of the bolsters 110 at the proximal end 112 increases the surface area of the bolsters 110 that contacts the spine member 106, which reduces the pressure at the connections (e.g., the welded connections) between the bolsters 110 and the spine member 106.

The bolsters 110 also include mounting platforms 118 at respective distal ends 114. The mounting platforms 118 include locking assemblies 120 which couple to and secure the containers 10 to the rail car 90. For example, in certain embodiments, the bolsters 110 include two mounting platforms 118, each having a respective locking assembly 120. As a result, certain bolsters 110 of the rail car 90 may support two containers 10 during transportation.

The rail car 90 also includes platforms 122 at first and second ends of the rail car 90. The platforms 122 are arranged such than an operator may stand on the platforms 122 to secure the rail car 90 to adjacent cars via couplers 124 positioned at the first and second ends of the rail car 90.

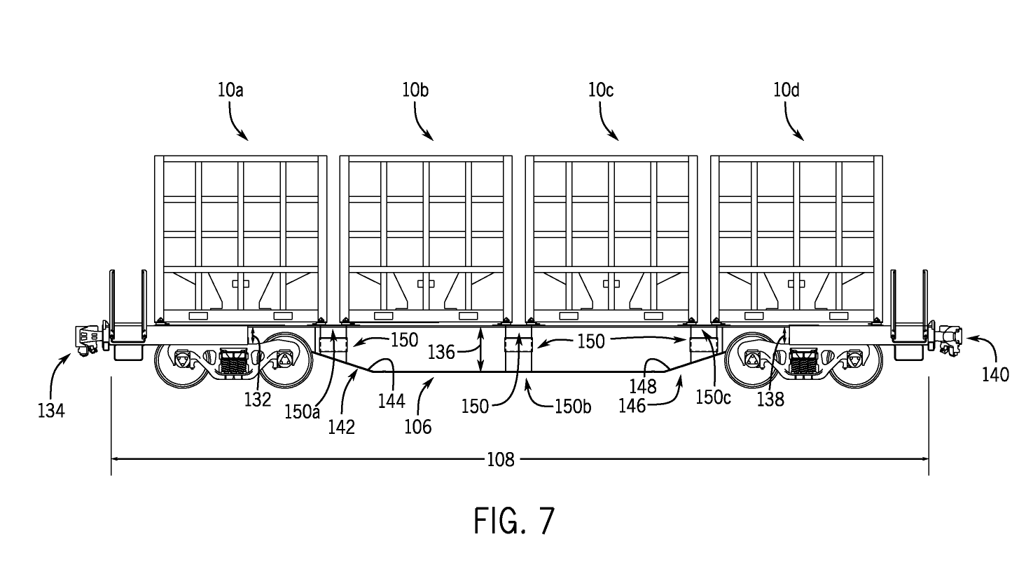

FIG. 7 is a side elevation view of the rail car 90 having four containers 10 positioned in a side-by-side configuration along the length 108 of the rail car 90. As shown, the containers 10 are substantially symmetrical about a midpoint 130 of the rail car 90, thereby distributing the weight across the trucks 98. Centering the weight substantially above the midpoint of the rail car 90 also improves the handling and transportation properties of the rail car 90. For example, the center of gravity of the rail car 90 is positioned in a location having substantially equal support on each side of the midpoint 130. As a result, as the rail car 90 is pulled along tracks, turns or curvatures in the track can be accommodated without sacrificing the speed at which the rail cars 90 can be moved. Moreover, as the rails cars 90 are pulled up elevation changes, the likelihood of the rail cars 90 shifting and/or sliding is substantially decreased because of the positioning of the center of gravity along the length 108 of the rail car 90.

As described above, the height (e.g., elevation) of the spine member 106 increases at approximately the midpoint 130. For example, a first spine member height 132 at a first end 134 is less than a second spine member height 136 at the midpoint 130. Moreover, a third spine member height 138 at a second end 140 is less than the second spine member height 136 and substantially equal to the first spine member height 132. As shown, a transition 142 between the first and second spine member heights 132, 136 includes an inclined section 144 and a transition 146 between the second and third spine member heights 136, 138 also includes an inclined section 148. As will be appreciated, the inclined sections 144, 148 redistribute the forces acting on the spine member 106 along their lengths, thereby enabling the spine member 106 to transition between the heights. Moreover, by having a larger second spine member height 136, the spine member 106 can handle a larger force from the weight on the rail car 90 because the larger cross-sectional area is less prone to bending and/or deformation than a smaller cross-sectional area. Furthermore, the substantially smooth transitions 142, 148 along the inclined sections 144, 148 facilitates improved force transfer than a sharp transition and maintains the structural integrity of the spine member 106 along the length 108.

In the illustrated embodiment, the spine member 106 further includes reinforcing structures 150 located at various locations along the length 108. In other words, the reinforcing structures 150 are strategically located at areas along the length 108 where force transfer is likely to occur. For example, the reinforcing structure 150a is positioned at the transition 142, the reinforcing structure 150b is positioned at the midpoint 130, and the reinforcing structure 150c is positioned at the transition 146. Moreover, as will be described below, the bolsters 110 and the mounting platforms 118 of the bolsters 110 are also positioned proximate the reinforcing structures 150.

In certain embodiments, the reinforcing structures 150 may include cross-bracing, gussets, or the like to improve the structural integrity of the spine member 106 while also facilitating the height change of the spine member 106. For example, the reinforcing structures 150 may include cross-bracing positioned at approximately the center of the transitions 142, 146. The cross-bracing may absorb at least a portion of the force exerted on the transitions 142, 146 by the containers 10. Moreover, in certain embodiments, the reinforcing structures 150 may extend radially outward toward the support rails 92, thereby further improving the structural integrity of the spine member 106. For example, the reinforcing structures 150 may be gussets that couple the spine member 106 to the support rails 92. Accordingly, the reinforcing structures 150 can enable the overall weight of the rail car 90 to be reduced because the spine member 106 has the variable height, thereby decreasing the total amount of material utilized by the spine member 106.

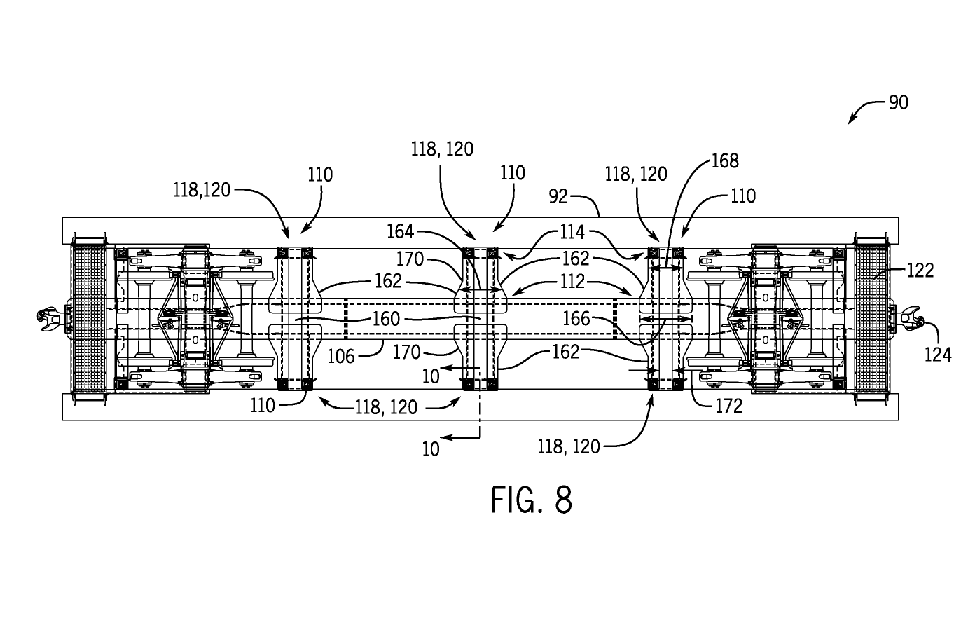

FIG. 8 is a top plan view of an embodiment of the rail car 90 having the bolsters 110 coupled to the spine member 106 and extending radially outward toward the support rails 92. In the illustrated embodiment, the bolsters 110 include cross members 160 transversely mounted to the spine member 106. As shown, the cross members 160 extend laterally off of the spine member and extend radially outward toward the support rails 92. Further, in the illustrated embodiment, top plates 162 mount to the spine member 106 on opposite sides of the cross members 160. In certain embodiments, the top plates 162 cover the cross members 160. That is, the top plates 162 may include slots or recesses to receive the cross members 160 and to mount to opposite sides of the cross members 160.

As described above, a width 164 of the bolsters 110 (e.g., the top plates 162) is greater at the proximal end 112 than at the distal end 114. For example, a first bolster width 166 is greater than a second bolster width 168. Moreover, the bolsters 110 include a bolster transition 170 between the first bolster width 166 and the second bolster width 168. As described below with respect to the transitions 142, 146, the bolster transition 170 facilitates distribution of the forces acting on the bolsters 110 over a larger surface area at the spine member 106. Accordingly, the pressure distributed over the spine member 106 is decreased. Further, in the illustrated embodiment, the first and second bolster widths 166, 168 are greater than a cross member width 172. That is, the cross member 160 is substantially contained within the bolster 110 by the top plate 162.

In the illustrated embodiment, the bolsters 110 are arranged in a spaced relationship along the length 108 of the spine member 106. For example, in the illustrated embodiment, the bolsters 110 are substantially aligned with the reinforcement structures 150. However, in other locations, the bolsters 110 may be positioned away from the reinforcement structures 150. In this manner, the bolsters 110 are spaced apart such that the mounting platforms 118 are positioned at intervals that enable containers 10 to couple to the rail car 90. For example, the mounting platforms 118 and the locking assemblies 120 may interact with the openings 84 in the corner posts 38 of the container 10. As a result, the bolsters 110 are arranged such that the locking assemblies 120 align with the containers 10 when the containers are arranged in a side-by-side configuration on the rail car 90.

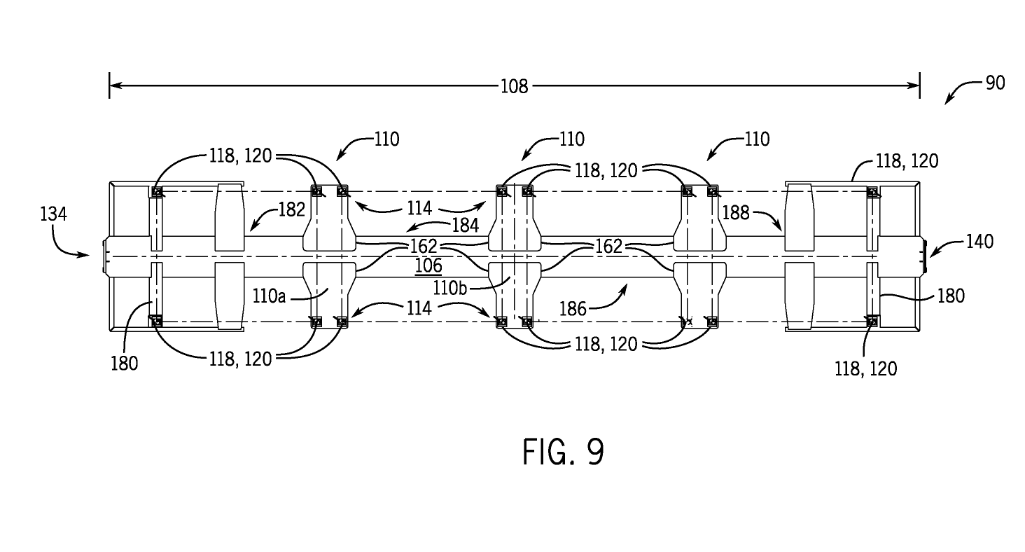

FIG. 9 is a top plan view of an embodiment of the rail car 90. It is noted that several features have been removed for clarity. For example, in the illustrated embodiment, the trucks 98 have been removed. As described above, the bolsters 110 are arranged in a spaced apart relationship along the length 108 of the spine member 106. In the illustrated embodiment, there are three bolsters 110, however, in other embodiments, there may be more or fewer bolsters 110. For example, the rail car 90 may include two bolsters 110 and be configured to carry three rail cars. Moreover, in other embodiments, the rail car 90 may include 1, 2, 5, 6, 7, 8, 9, 10, or any other suitable number of bolsters 110 to facilitate transportation of the containers 10. Furthermore, as shown in the illustrated embodiment, locking support members 180 are arranged on the first and second ends 134, 140 of the rail car 90. The locking support members 180 are coupled to the spine member 106 and extend radially outward toward the support rails 92 in the same manner as the bolsters 110. Moreover, the locking support members 180 include the mounting platform 118 and the locking assembly 120. The locking support members 180 are positioned proximate the platforms 122 and correspond to the bolsters 110 to enable the containers 10 to be positioned on rail car 90.

In the illustrated embodiment, the mounting platforms 118 are arranged on the distal end 114 of the bolsters 110 and the locking support members 180 approximately 8 to 9 feet from the corresponding locking support members 180 on the opposite end of the bolsters 110. As such, the rail cars 90 maintain a standardized width and can be transported on commercial railroads across the United States and in other countries. For example, limiting the width of the rail car 90 to approximately the width of the containers 10 enables the rail car 90 to pass through tunnels and conventional rail yards without modifications to existing infrastructure. Furthermore, because the width of the rail cars 90 is approximately as wide as the containers 10, the amount of material utilized to form the rail cars 90 may be reduced, thereby further reducing the overall weight of the rail cars 90, which as will be described below, enables the rail cars 90 to carry several containers 10 (e.g., four containers) over existing infrastructure, such as bridges, economically and quickly without utilizing multiple deliveries due to train length and weight concerns.

The illustrated rail car 90 includes a first section 182, a second section 184, a third section 186, and a fourth section 188. Each section 182, 184, 186, 188 corresponds to and receives a container 10. For example, with respect to the first section 182, a first container 10a engages the locking assemblies 120 arranged on the locking support member 180 at the first end 134 and the locking assemblies 120 on the first bolster 110a arranged on the spine member 106. Further, a second container 10b engages the locking assemblies 120 arranged on the first bolster 110 and the locking assemblies 120 on a second bolster 110b. In this manner, four containers 10a, 10b, 10c, 10d may be positioned along the rail car 90 because adjacent mounting platforms 118 and locking mechanism 120 are arranged to accommodate up to two containers per bolster 110, in the illustrated embodiment.

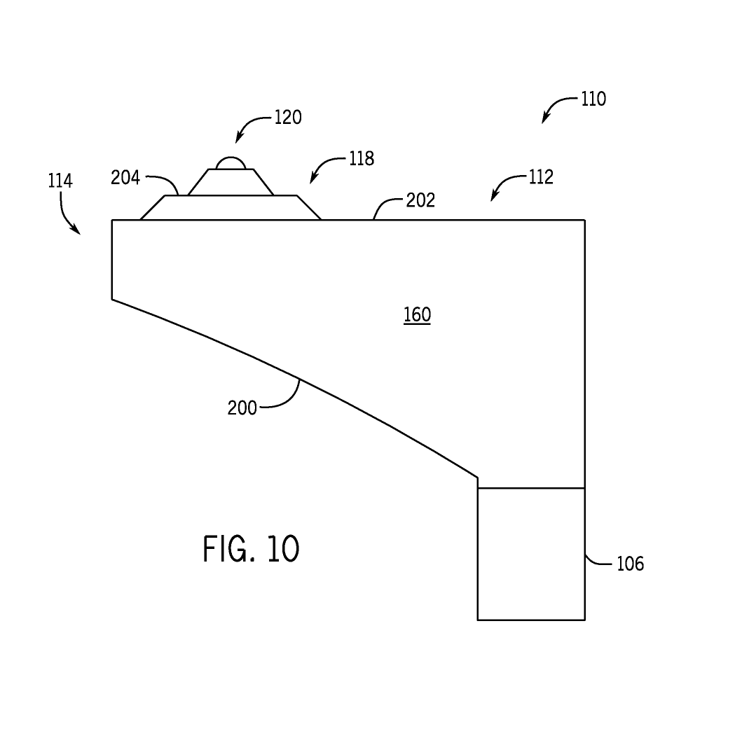

FIG. 10 is a cross-sectional view of the bolster 110 taken along line 10-10 of FIG. 8. In the illustrated embodiment, the cross member 160 has a variable height (e.g., elevation, thickness) from the distal end 114 to the proximal end 112. In other words, the thickness of the cross member 160 increases closer to the spine member 106 (e.g., the thickness proximal to the spine member 106 is greater than the thickness distal from the spine member 106). The cross member 160 includes a transition 200 that represents the change in thickness along the length of the cross member 160. As described above, the transition facilitates the distribution of force along the length of the cross member 160 toward the spine member 106. While not pictured in the illustrated embodiment, in certain embodiments, the top plates 162 may also include a variable height and a transition. However, in other embodiments, the top plates 162 may have a uniform thickness.

Further illustrated in FIG. 10 is the mounting platform 118. As shown, the mounting platform extends vertically above a top surface 202 of the cross member 160. In operation, the containers 10 are positioned on the mounting platforms 118 and rest on the container surface 204. The locking assembly 120 mounted on the mounting platform 118 extends into the opening 84 in the corner posts 38, and is activated to lock the container 10 into place on the mounting platform 118. In this manner, the container 10 may be coupled to the rail car 90 at four contact points, thereby blocking movement in at least 6 directions (e.g., up, down, left, right, front, back). Moreover, the four contact point locks also block twisting or turning of the containers 10. As mentioned above, the securement of the containers 10 to the rail car 90, coupled with the designed low center of gravity to facilitate coming and movement, enables the rail car 90 to transport multiple containers 10 (e.g., four containers) while distributing the weight evenly across the rail car 90. Moreover, the arrangement of the containers 10 on the rail car 90 enables the rail cars 90 to stay within regulatory restrictions for weight, height, and length for travel over bridges and through rail yards. As a result, more containers 10 may be shipped with a smaller trail of rail cars 90 and without special permitting or routing to comply with regulations.

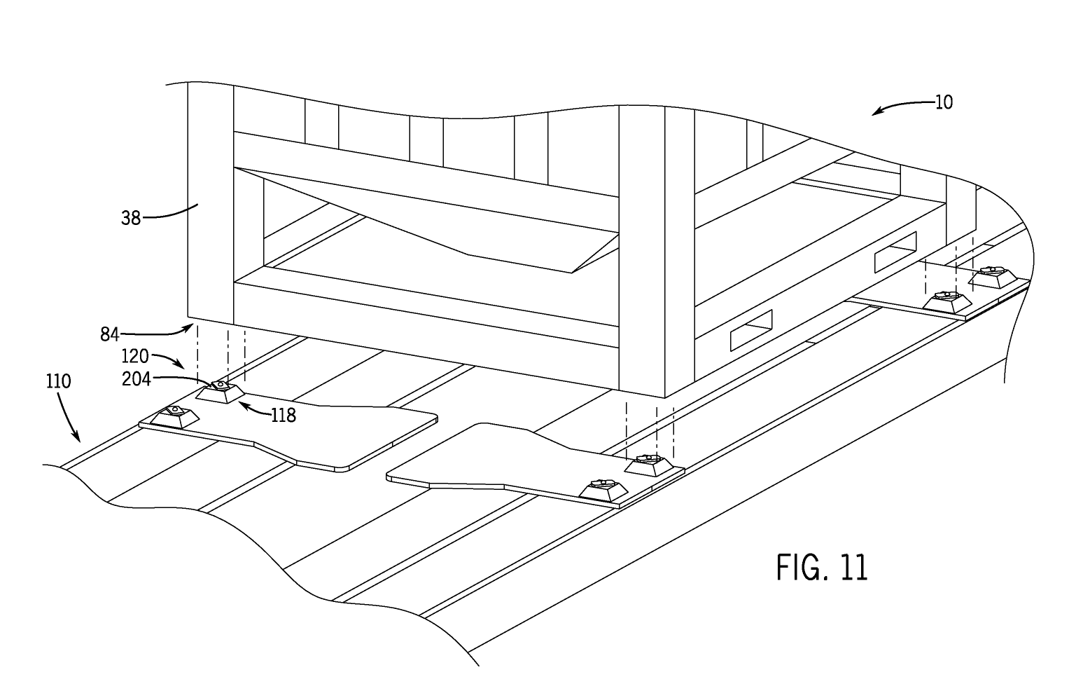

FIG. 11 is a perspective view of the container 10 being aligned with the locking assembly 120. It is appreciated that features have been removed from FIG. 11 for clarity. As shown, the corner post 38 of the container 10 is substantially aligned with the mounting platform 118 such that the locking assembly 120 will engage the opening 84 of the corner post 38 when the bottom of the container 10 moves into contact with the container surface 204. As shown, the arrangement of the mounting platform 118 and the locking assembly 120 is particularly selected to engage the containers 10 in one position (e.g., a position that enables the locking assembly 120 to engage the corner posts 38). For example, the locking assemblies 120 may be arranged such that the forks of a forklift can engage the container 10 and position the container 10 onto the rail car 90. As such, improper loading is blocked because if the container 10 were loaded in such a manner that the container 10 could not contact the container surface 204, the container 10 would not be locked to the rail car 90. When the container 10 is seated on the container surface 204, the locking assembly 120 is engaged and moved from an unlocked position to a locked position. The locked position secures the container 10 to the rail car 90, thereby preparing the container 10 for transport. It is appreciated that a variety of locking mechanisms may be utilized to secure the container 10 to the rail car 90. For example, the locking assembly 120 may include twist locks, cable tie downs, tongue and groove fasteners, or the like.

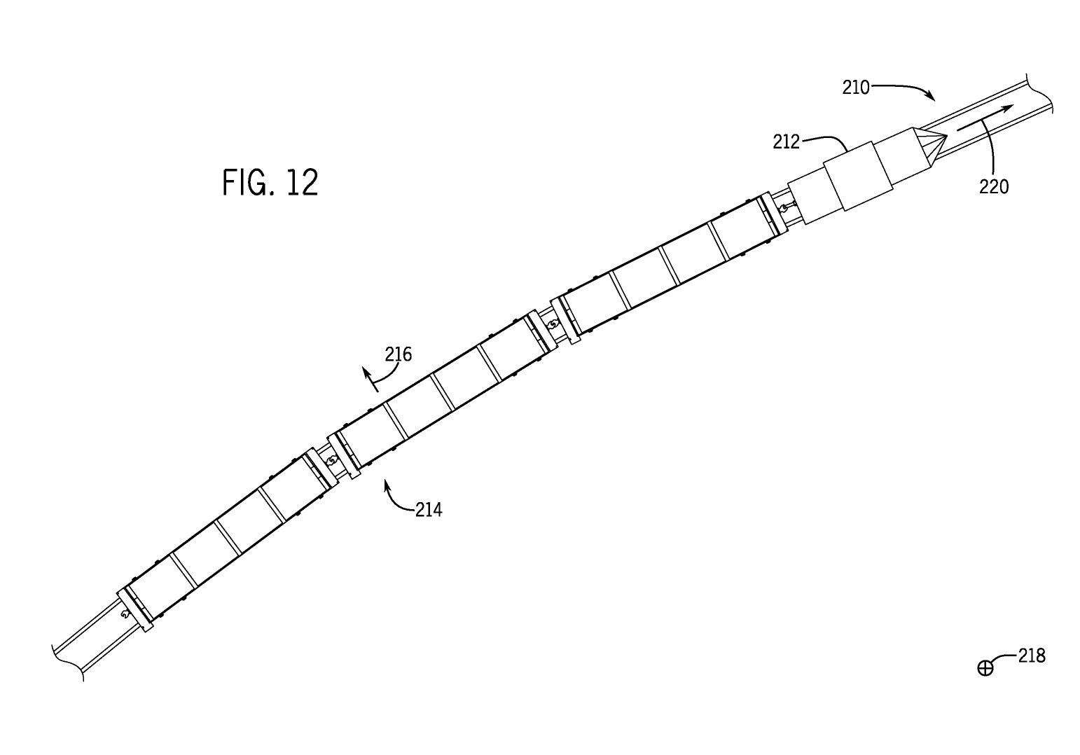

FIG. 12 is a top view of rail cars 90 transporting the containers 10 along a section of rail 210. As described above, the rail cars 90 are configured to enable an arrangement of the containers 10 along a length 108 to substantially center the weight over the midpoint 130. As a result, the center of gravity of the rail cars 90 is balanced, thereby enabling the rail car 90 to handle a large load (e.g., between approximately 216,000 pounds to 232,000 pounds) while maintaining speed on curves, hills, and the like. In the illustrated embodiment, three rail cars 90 are coupled to an engine 212, however, in other embodiments, more or few rails cars 90 may be coupled to the engine 212. Each rail car 90 is carrying four containers 10 along a curved portion 214 of the rail section 210. As shown by the arrow 216, a force is acting on the rail cars 90 along the curve, thereby driving the rail cars 90 radially outward away from a center 218. By balancing the containers 10 along the length 108 of the rail car 90, the effect of the force 216 may be reduced, thereby enabling the engine 212 to travel along the curved portion 214 without significant adjustments to speed. For example, the engine 212 can keep traveling in a direction of travel 220, represented by the arrow without adjusting for speed while still maintaining the large load supported by the rail cars 90. Moreover, as described above, because in the illustrated embodiment four containers 10 are positioned on the rail cars 90, the overall length of the system may be reduced. For example, if the rail car 90 were only capable of supporting two containers 10, the length of the system would effectively double. Accordingly, different considerations (e.g., bridge length, weight limits, rail yard space, etc.) would come under scrutiny to determine whether the containers 10 could be shipped economically via rail. However, because the rail cars 90 are capable of supporting the weight of the containers 10, transportation of the containers 10 may be accomplished without special considerations for weight, height, length, or other factors.

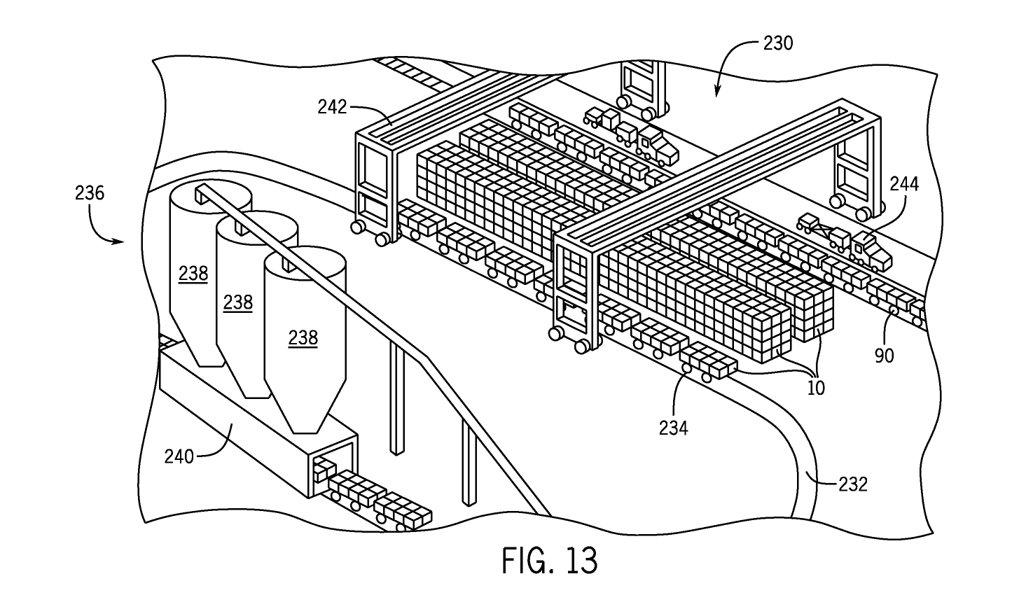

As described above, the rail cars 90 can be utilized to support and transport the containers 10 along railways. FIG. 13 is a schematic perspective view of an embodiment of a proppant delivery system 230. The system 230 includes a track 232 formed in the nature of a circuit. A container-hauling trolley 234 is movably positioned on the track 232 and configured to travel along the circuit to position the containers 10 to receive proppant. For example, in the illustrated embodiment, a proppant supply station 236 is positioned on the track 232. As shown, the circuit continues below the proppant supply station 236, positioned adjacent the track 232, to enable the trolley 234 to move one or more containers into position to receive proppant from one or more silos 238. For example, the trolley 234 may transition the containers 10 into a loading bay 240 to receive the proppant (e.g., from an opening in the bottom of the silos 238). As the circuit continues, one or more cranes 242 (e.g., a gantry crane) may be utilized to remove the filled containers 10 from the trolley 234 and to stage the containers 10 adjacent to the rail section 210 having the rail cars 90 or a roadway having trucks 244 for transporting the proppant. For example, in certain embodiments, the crane 242 may load the containers 10 directly onto the rail car 90 or the truck 244. In other embodiments, the crane 242 may stage (e.g., stack) the containers 10 proximate the rail section 210 or the roadway for later loading (e.g., via a forklift). In certain embodiments, the silo 238, rail section 210, and/or the roadway are positioned at the mine where the proppant is gathered. As a result, the container 10 and the rail cars 90 may be utilized to transport the proppant directly from the mine, thereby improving efficiencies and reducing costs by reducing the number of handling steps the proppant goes through before reaching the well site.

In embodiments, as the empty proppant containers 10 arrive back from the field by either rail car 90 or by truck 244, the rail cars 90 or trucks 244 are positioned on the track or road that runs underneath the cranes 242. The cranes 242 remove the empty containers 10 from the trucks 244 or rail cars 90 to the empty inventory stack. Once the empty containers 10 are removed from the rail cars 90 or trucks 244, the cranes 242 will begin to reload the rail cars 90 or trucks 242 from the inventory stack of full containers. The train or trucks will depart from the proppant mine once they are completely reloaded. The filling of the proppant containers 10 by the use of the trolleys 234 can occur simultaneous to the above-described process. A constant flow of empty proppant containers 10 are guided into the loading bay that are filled with proppant from the silos 238. Once filled, the proppant containers 10 exit the loading bay, and then travel around the trolley track 232 until they are positioned underneath the cranes 242. These filled proppant containers 10 are then removed from the trolley cars, placed onto the inventory stack of filled containers 10, and then replaced by empty proppant containers 10 from the inventory stack of empty containers 10. The replacement empty containers 10 are sent to the loading bay along the track and the trolleys so as to repeat the process.

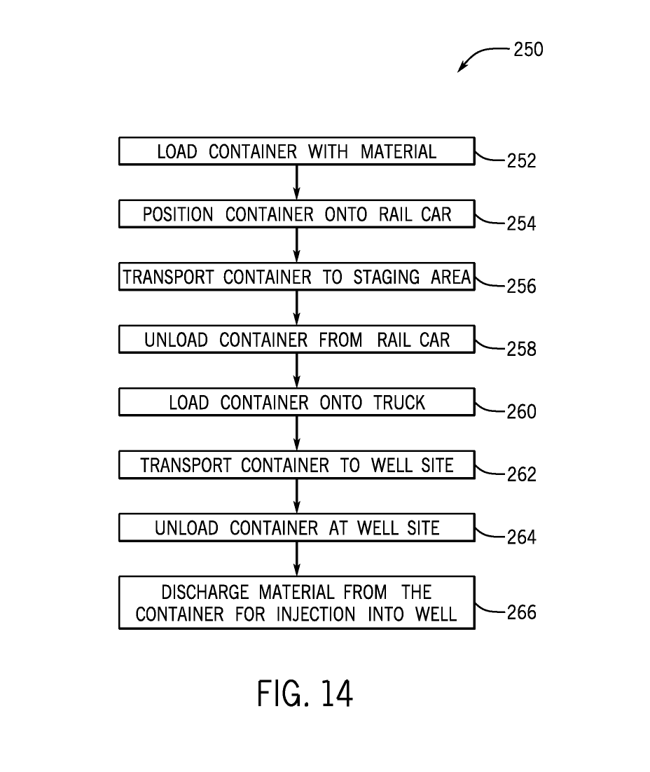

FIG. 14 is a flow chart of an embodiment of a method 250 for loading and transporting material (e.g., proppant) from a mine to a well site. The container 10 is loaded with material at the mine (block 252). For example, as described above, the proppant may be dried and conveyed into silos 238 which are utilized for long term storage. The containers 10 may be positioned beneath the silos 238 to load the containers 10. The containers 10 are then positioned on the rail cars 90 (block 254). The rail cars 90 may be specially designed to accommodate the weight of the containers 10. For example, in the illustrated embodiments, the rail cars 90 include a reinforced spine member 106 and bolsters 110 designed to receive and support the containers 10. Moreover, the rail cars 90 include the locking assemblies 120 to secure the containers 10 to the rail car 90.

Thereafter, the containers 10 are transported to a staging area (block 256). For example, the staging area may be located near the well site (e.g., within driving distance). The containers 10 are then unloaded at the staging area (block 258). For example, the containers 10 may be arranged in a stacked orientation to reduce the foot print of the containers 10 at the staging area. Then, the containers 10 may be loaded onto the trucks 244 (block 260). The trucks 244 transport the containers 10 to the well site (block 262) for subsequent unloading (block 264). At the well site, the containers 10 may be arranged in a stacked orientation to reduce the foot print of the containers 10 at the well site. Then, the containers 10 may be discharged such that the proppant can be mixed and injected into a well (block 266). Accordingly, the method 250 illustrates how the proppant can be loaded a single time, at the mine, and then the storage container 10 is moved from the rail car 90, to the staging area, to the truck 244, and then directly to the well site with minimal handling steps. As a result, the cost of transporting the proppant from the mine to the well site is reduced. Moreover, the likelihood of contamination of the proppant is also reduced because the proppant remains within the sealed container 10 for the duration of the trip, until the proppant is discharged from the container 10.

As described in detail above embodiments of the present disclosure are directed toward the rail car 90 having one or more bolsters 110 arranged along the length 108 over the spine member 106. The spine member 106 includes a variable height (e.g., elevation) along the length 108 such that the first spine member height 132 at the first end 134 of the rail car 90 is less than the second spine member height 136 at the midpoint 130. Moreover, the third spine member height 138 at the second end 140 is less than the second spine member height 136. As a result, the spine member 106 has a greater cross-sectional area at the midpoint 130, which is subject to a greater force due to the load placed on the rail car 90. Accordingly, the weight of the rail car 90 is reduced by utilizing less material at the first and second ends 134, 140. As described above, the bolsters 110 include the mounting platform 118 to receive and support the containers 10. The mounting platforms 118 extend vertically above the top surface of the 202 of the bolster 110 and elevate the containers 10 above the spine member 106. Further, the mounting platforms 118 include the locking assemblies 120 to secure the containers 10 to the rail cars 90. Accordingly, the rail car 90 may receive several containers 10 in a side-by-side arrangement to enable economical transportation of containers 10 filled with proppant material from a mine to a well site.

The present application claims priority to and the benefit of U.S. Provisional Application No. 62/139,323, filed on Mar. 27, 2015, and titled “Spine Car for Transporting Proppant Containers,” which is hereby incorporated by reference in its entirety. The present application further is a continuation-in-part of U.S. patent application Ser. No. 14/738,485, filed Jun. 12, 2015, and titled “Apparatus for the Transport and Storage of Proppant,” which is a continuation-in-part of U.S. application Ser. No. 13/768,962, filed on Feb. 15, 2013, and titled “Support Apparatus for Moving Proppant from a Container in a Proppant Discharge System,” which is a continuation-in-part of U.S. application Ser. No. 13/628,702, filed on Sep. 27, 2012, and titled “Proppant Discharge System and a Container for Use in Such a Proppant Discharge System,” which is a continuation-in-part of U.S. application Ser. No. 13/555,635, filed on Jul. 23, 2012, and titled “Proppant Discharge System Having a Container and the Process for Providing Proppant to a Well Site.” U.S. patent application Ser. No. 14/738,485 further claims priority to and the benefit of U.S. Provisional Application 62/012,153, filed on Jun. 13, 2014, and titled “Process and System for Supplying Proppant from a Mine to a Transport Vehicle,” U.S. Provisional Application 62/012,165, filed on Jun. 13, 2014, and titled “Apparatus for the Transport and Storage of Proppant,” and U.S. Provisional Application 62/139,323, filed on Mar. 27, 2015, and titled “Spine Car for Transporting Proppant Containers,” each of which is hereby incorporated by reference in its entirety. The present application still further is a continuation-in-part of U.S. Patent Application No. 29/537,567, filed on Aug. 27, 2015, and titled “Train Car for Proppant Containers,” which is a reissue of U.S. Pat. No. D703,582, filed on May 17, 2013, and titled “Train Car for Proppant Containers,” each of which is hereby incorporated by reference in its entirety. The present application yet still further is a continuation-in-part of U.S. patent application Ser. No. 14/310,648, filed on Jun. 20, 2014, titled “Method of Delivering, Transporting, and Storing Proppant for Delivery and Use at a Well Site,” which is continuation of PCT Application No. PCT/US13/32819, filed on Mar. 18, 2013, titled “System of Delivering and Storing Proppant for Use at a Well Site and Container for Such Proppant,” which claims the benefit of U.S. patent application Ser. No. 13/427,140, filed on Mar. 22, 2012, titled “System of Delivering and Storing Proppant for Use at a Well Site and Container for Such Proppant,” now U.S. Pat. No. 8,622,251, issued on Jan. 7, 2014, which is a continuation-in-part of U.S. patent application Ser. No. 13/332,937 filed on Dec. 21, 2011, titled “Proppant Storage Vessel and Assembly Thereof,” now U.S. Pat. No. 8,827,118, issued on Sep. 9, 2014, all of which are incorporated herein by reference in their entireties.

The foregoing disclosure and description of the invention is illustrative and explanatory of the embodiments of the invention. Various changes in the details of the illustrated embodiments can be made within the scope of the appended claims without departing from the true spirit of the invention. The embodiments of the present invention should only be limited by the following claims and their legal equivalents.

1. A rail car for supporting and transporting one or more containers storing proppant therein, the rail car comprising:
a spine member extending from a first end to a second end of the rail car, the spine member having a variable height that is greater at a midpoint of the spine member than at the first end and at the second end;
a bolster arranged on a top surface of the spine member and extending laterally off of the spine member in two directions, the bolster having a greater width proximate the spine member than at a distal end of the bolster;
a mounting platform positioned on the distal end of the bolster and having a container surface that receives the one or more containers when arranged thereon, the mounting platform extending vertically from the bolster to position the one or more containers above a top surface of the bolster when positioned thereon; and
a locking assembly positioned on the mounting platform to engage the one or more containers when positioned thereon, the locking assembly securing the one or more containers to the rail car when moved from an unlocked position to a locked position.

2. The rail car of claim 1, wherein the bolster comprises:
a cross member extending across the spine member, the cross member being coupled to one or more support rails extending about at least a portion of a periphery of the rail car; and
one or more top plates positioned about the cross member, the one or more top plates having a greater width than the cross member.

3. The rail car of claim 2, wherein the cross member comprises a variable thickness that changes along a length of the cross member such that the thickness is greater proximate the spine member than the thickness distal the spine member.

4. The rail car of claim 1, wherein the spine member comprises reinforcing structures positioned at intervals along a length of the spine member, the reinforcing structures being arranged at intervals between changes in height of the spine member.

5. The rail car of claim 4, wherein the reinforcing structure is positioned at the midpoint of the spine member.

6. The rail car of claim 4, wherein the bolster is substantially aligned with at least one reinforcing structure.

7. The rail car of claim 1, comprising a plurality of bolsters arranged in a spaced relationship along a length of the spine member, the bolsters being positioned such that a container of the one or more containers rests on at least two bolsters when positioned on the rail car.

8. The rail car of claim 1, comprising a locking support member positioned adjacent a platform, the locking support member comprising the mounting platform and the locking assembly and being arranged to at least partially support a container of the one or more containers.

9. The rail car of claim 1, wherein the rail car receives at least four containers having a total weight of between approximately 216,000 pounds and 232,000 pounds.

10. A proppant storage and transportation system, comprising:
a plurality of containers arranged in a side-by-side configuration, each container of the plurality of containers comprising a pair of side walls, a pair of end walls, a top, a bottom, and inclined surfaces extending in a downward direction from the side walls and the end walls toward a discharge opening in the bottom to direct proppant stored therein out of the container via the discharge opening; and
a rail car comprising:
a spine member extending from a first end to a second end, the spine member having a variable height that is greater at a midpoint than at the first and second ends;
a plurality of bolsters arranged along a length of the spine member, the plurality of bolsters extending laterally outward from the spine member, each bolster of the plurality of bolsters having a distal end that is narrower than a proximal end, and being arranged such that at least one container of the plurality of containers is in contact with at least one bolster of the plurality of bolsters when the at least one container is positioned on the rail car; and
one or more mounting platforms arranged on the distal end of each bolster of the plurality of bolsters, the one or more mounting platforms extending vertically above a top surface of each bolster of the plurality of bolsters such that the at least one container arranged thereon is not in contact with the top surface of each bolster of the plurality of bolsters.

11. The system of claim 10, wherein each bolster of the plurality of bolsters comprises two mounting platforms and each bolster of the plurality of bolsters supports two containers of the plurality of containers when positioned thereon.

12. The system of claim 10, comprising a plurality of locking support members, each locking support member of the plurality of locking support members positioned at an opposite end of the rail car, and each locking support member having a mounting platform that is aligned with an adjacent bolster of the plurality of bolsters such that one container is supported by each locking support member of the plurality of locking support members when the plurality of containers is positioned on the rail car.

13. The system of claim 10, comprising a locking assembly arranged on each mounting platform, the locking assembly being movable between a locked position and an unlocked position and engaging at least one container of the plurality of containers to secure the at least one container of the plurality of containers to the rail car when positioned thereon.

14. The system of claim 10, comprising reinforcing structures arranged on the spine member and substantially aligned with each bolster of the plurality of bolsters, the reinforcing structures enhancing the structural integrity of the spine member such that the rail car is capable of supporting loads between approximately 216,000 pounds and 232,000 pounds.

15. The system of claim 10, comprising one or more support rails extending about at least a portion of a periphery of the rail car, wherein each bolster of the plurality of bolsters is coupled to the one or more support rails at the distal end.

16. A method for filling and transporting proppant containers, the method comprising:
filling the proppant container through an opening in a top wall, the proppant container having inclined surfaces that direct the proppant therein toward a discharge opening;
positioning the proppant container onto a rail car, the rail car having one or more bolsters arranged transverse to a spine member, the one or more bolsters comprising mounting platforms to receive the container and to elevate the container above a top surface of the one or more bolsters;
transporting the proppant container, via the rail car, to a staging area; and
unloading the proppant container from the rail car and arranging the proppant container in a stacked configuration with one or more other proppant containers.

17. The method of claim 16, comprising arranging a plurality of proppant containers onto the rail car in a side-by-side configuration, each proppant container being aligned with a locking assembly arranged on respective mounting platforms of the one or more bolsters, and the locking assemblies securing the plurality of proppant containers to the rail car when moved to a locked position.

18. The method of claim 16, comprising loading the proppant container onto a truck, via a fork lift, from the stacked configuration at the staging area and transporting the proppant container to a well site.

19. The method of claim 16, wherein filling the proppant container comprises filling the proppant container at a proppant mining quarry.

20. The method of claim 16, comprising transporting empty proppant containers to a proppant mining quarry, via the rail car.
